(19) United States
(12) Patent Application Publication
(10) Pub. No.: US 2024/0325245 A1
(43) Pub. Date: Oct. 3, 2024

(54) LIQUID STORAGE CONTAINER AND METHOD FOR MANUFACTURING LIQUID STORAGE CONTAINER

(71) Applicant: JMS CO., LTD., Hiroshima (JP)

(72) Inventor: Hiroto SAKANE, Hiroshima (JP)

(21) Appl. No.: 18/579,237

(22) PCT Filed: Jun. 27, 2022
(86) PCT No.: PCT/JP2022/025452

§ 371 Date: Jan. 12, 2024

(30) Foreign Application Priority Data
Jul. 14, 2021 (JP) 2021-116556

(51) Int. Cl. A61J 1/10; B29C 65/00; B29L 31/00; B65D 17/42

(52) U.S. Cl. CPC A61J 1/10; B29C 66/433; B65D 17/42; B29L 2031/7148

(57) ABSTRACT

Provided is a liquid storage container having a puncture port capable of ensuring hermeticity at the time of puncturing regardless of the size of an insertion part of a puncture instrument and also capable of reducing the loss of contents. A puncture port 40, which is provided in a liquid storage container 1 for storing liquid and is punctured by a puncture instrument 200 having a needle tube portion 210 formed with a through hole 215, comprises a cylindrical port main body portion 43, a liquid discharge portion 30, and a first partition 411 and a second partition 421 provided in the port main body portion 43, wherein the port main body portion 43 is joined to the liquid discharge portion 30 at a boundary portion between a liquid accommodation portion 10 and the liquid discharge portion 30.

### TECHNICAL FIELD

The present invention relates to a liquid storage container including a puncture port and a method of manufacturing the liquid storage container.

### BACKGROUND ART

Conventionally, liquid storage containers are used to store medical liquids such as blood and cells. Such a liquid storage container includes a puncture port into which a puncture instrument such as a bottle needle or a syringe for taking out contents or injecting a liquid such as saline is inserted. The puncture instrument includes a needle tube portion in which a through hole is provided. On the other hand, the puncture port has a cylindrical structure and includes a partition thereinside. When the liquid stored in the liquid storage container is taken out by the puncture instrument and the liquid is injected into the liquid storage container, the partition of the puncture port is punctured with the needle tube portion of the puncture instrument to penetrate the partition. Thus, the contents are taken out or injected through the needle tube portion. There is a demand for a liquid storage container with which the loss of the contents is small when the contents are taken out.

Leakage of contents may occur when puncturing a puncture instrument into a puncture port. Specifically, when the length of the opening portion of the through hole in the tip portion of the needle tube portion of the puncture instrument is larger than the thickness of the partition, the inside and the outside of the puncture port communicate with each other in the middle of the penetration of the opening portion through the partition, resulting in leakage. Thus, leakage of the contents causes loss of the contents, and is not preferable from the viewpoint of maintaining sterility of the contents.

Therefore, a puncture instrument (medical plastic needle) capable of sealing a puncture port by fitting the puncture instrument and the puncture port before the tip of the puncture instrument penetrates the partition of the puncture port has been proposed (for example, see Patent Document 1).

### CITATION LIST

### Patent Document

Patent Document 1: Japanese Unexamined Patent Application, Publication No. 2007-196048

### DISCLOSURE OF THE INVENTION

### Problems to be Solved by the Invention

In the puncture instrument proposed in Patent Document 1, it is necessary to change the size of the outer diameter of the insertion portion (fitting portion) of the puncture instrument in accordance with the size of the inner diameter of the puncture port. Therefore, depending on the size of the puncture instrument, the sealing performance of the puncture port may not be maintained.

Accordingly, it is an object of the present invention to provide a liquid storage container capable of maintaining sealing performance when puncture is performed without being limited by the size of an insertion portion of a puncture instrument and capable of reducing the occurrence of loss of contents, and a method of manufacturing the liquid storage container.

### Means for Solving the Problems

An embodiment of the present invention is directed to a liquid storage container including a puncture port puncturable by a puncture instrument including a needle tube portion having a through hole provided therein, and the liquid storage container includes: a liquid accommodation portion that accommodates a liquid; and a liquid discharge portion that discharges the liquid accommodated in the liquid accommodation portion. The puncture port includes: a cylindrical port main body portion; and a first partition and a second partition provided in the port main body portion. The port main body portion is joined with the liquid discharge portion at a boundary portion between the liquid accommodation portion and the liquid discharge portion.

Further, it is preferable that the puncture port includes a cylindrical first port member having one end portion closed by the first partition and a cylindrical second port member having one end portion closed by the second partition, a portion or all of the second port member is provided at the boundary portion inside the first port member, and the first port member, the second port member, and the liquid discharge portion are welded at the boundary portion.

In addition, it is preferable that the first port member and the second port member are provided in the liquid discharge portion such that an opening on one other end portion of each of the first port member and the second port member face the liquid accommodation portion.

Moreover, it is preferable that the second port member includes a small diameter portion having an outer diameter substantially equal to an inner diameter of the first port member at the one end portion of the second port member, and a large diameter portion which is continuous with the small diameter portion and has an outer diameter substantially equal to an outer diameter of the first port member at the other end portion of the second port member, and the second port member is welded to the liquid discharge portion via the first port member at the small diameter portion, and welded to the liquid discharge portion at the large portion.

Further, it is preferable that the liquid accommodation portion is provided by welding peripheral edge portions of a set of sheet-shaped members provided in an opposite manner, and the set of sheet-shaped members, the first port members, and the second port members are made of a same material.

In addition, it is preferable that a distance between the first partition and the second partition in a puncture direction is longer than at least a length of an opening portion of the through hole at a tip portion of the needle tube portion in the puncture direction.

Moreover, an embodiment of the present invention is directed to a method of manufacturing a liquid storage container that stores a liquid, the liquid storage container including a puncture port puncturable by a puncture instrument including a needle tube portion having a through hole provided therein, a liquid discharge portion, and a liquid accommodation portion, the method including: an insertion step of inserting a portion or all of a second port member into a first port member in a state in which an opening on one other end portion of the first port member having one end portion closed by a first partition and an opening on one other end portion of the second port member having one end portion closed by a second partition face in a same direction; a providing step of providing the first port member and the second port member between a set of sheet-shaped members overlapped in an opposite manner after the insertion step; a welding step of welding a portion where the first port member, the second port member, and the set of sheet-shaped members overlap after the providing step; and a liquid accommodation portion forming step of welding peripheral edge portions of the set of sheet-shaped members to form the liquid accommodation portion on a side where the openings of the first port member and the second port member are located. The liquid accommodation portion forming step further includes welding the set of sheet-shaped members to include the portion welded in the welding step.

Further, it is preferable that the second port member includes a small diameter portion having an outer diameter substantially equal to an inner diameter of the first port member at the one end portion of the second port member, and a large diameter portion which is continuous with the small diameter portion and has an outer diameter substantially equal to an outer diameter of the first port member at the other end portion of the second port member. It is also preferable that the insertion step further includes inserting the small diameter portion of the second port member into the first port member until a step difference between the small diameter portion and the large diameter portion of the second port member is brought into contact with the opening of the first port member, and the welding step further includes welding the second port member to the first port member and the liquid discharge portion at the small diameter portion, and welding the second port member to the liquid discharge portion at the large diameter portion.

### Effects of the Invention

According to the present invention, it is possible to provide a liquid storage container capable of maintaining sealing performance when puncture is performed without being limited by the size of an insertion portion of a puncture instrument and capable of reducing the occurrence of loss of contents, and a method of manufacturing the liquid storage container.

### BRIEF DESCRIPTION OF THE DRAWINGS

FIG. 1 is a plan view of a liquid storage container according to a first embodiment of the present invention.

FIG. 2 is an exploded perspective view of the liquid storage container according to the first embodiment.

FIG. 3 is a cross-sectional view taken along the line A-A of FIG. 1.

FIG. 4A is a view of a manufacturing step of the puncture port and the liquid storage container, and is a view of a step of overlapping a pair of sheet-shaped members having a three-dimensional shape in a state in which a port main body portion is provided in a recessed groove.

FIG. 4B is a view of a step of welding the vicinity of the port main body portion from the state shown in FIG. 4A.

FIG. 4C is a view of a step of providing a liquid introduction tube in a liquid introduction portion from the state shown in FIG. 4B.

FIG. 4D is a view of a step of forming a liquid storage container having a liquid accommodation portion and a puncture port accommodation portion by welding a peripheral edge portion of a set of sheet-shaped members from the state shown in FIG. 4C.

FIG. 5A is a schematic cross-sectional view of a manufacturing step of the puncture port according to a first embodiment, and is a diagram illustrating a step of inserting a portion of a second port member into a first port member.

FIG. 5B is a view of a state in which a welding pin is inserted into the second port member from the state shown in FIG. 5A.

FIG. 5C is a diagram for explaining a providing step of providing the first port member and the second port member between a pair of sheet-shaped members which are overlapped in an opposite manner from the state shown in FIG. 5B.

FIG. 5D is a diagram of a welding step of welding a portion where the second port member and the set of sheet-shaped members overlap with each other and a portion where the first port member, the second port member and the set of sheet-shaped members overlap with each other from the state shown in FIG. 5C.

FIG. 6A is an explanatory diagram of a modified example 1 of the puncture port according to the first embodiment.

FIG. 6B is a view of a state in which a welding pin is inserted into the second port member from the state shown in FIG. 6A.

FIG. 6C is a diagram for explaining a providing step of providing the first port member and the second port member between a pair of sheet-shaped members which are overlapped in an opposite manner from the state shown in FIG. 6B.

FIG. 6D is a diagram of a state in which a portion where a first port-shaped member, a second port-shaped member, and the pair of sheet-shaped members shown in FIG. 6A are overlapped is welded to each other.

FIG. 7A is an explanatory diagram of a modified example 2 of a puncture port according to the first embodiment.

FIG. 7B is a view of a state in which the welding pin is inserted into a second port member from the state shown in FIG. 7A.

FIG. 7C is a diagram for explaining a providing step of providing the first port member and the second port member between a pair of sheet-shaped members which are overlapped in an opposite manner from the state shown in FIG. 7B.

FIG. 7D is a diagram of a state in which a portion where the first port-shaped member, the second port-shaped member, and the pair of sheet-shaped members shown in FIG. 7A are overlapped is welded to each other.

FIG. 8 is a diagram of a procedure of using the liquid storage container according to the first embodiment and a state in which the liquid is accommodated in the liquid storage container.

FIG. 9 is a view of a state in which the liquid is accommodated in the liquid accommodation portion from the state shown in FIG. 8.

FIG. 10 is a view of a state in which the liquid introduction tube is fused from the state shown in FIG. 9.

FIG. 11 is a view of a state in which cells accommodated in the liquid accommodation portion are taken out, and a state in which the puncture port accommodation portion is opened (cut).

FIG. 12A is an explanatory diagram of when the puncture instrument punctures the puncture port according to the first embodiment of the present invention.

FIG. 12B is an explanatory diagram when the puncture instrument punctures the puncture port according to the first embodiment of the present invention.

FIG. 12C is an explanatory diagram when the puncture instrument punctures the puncture port according to the first embodiment of the present invention.

FIG. 12D is an explanatory diagram when the puncture instrument punctures the puncture port according to the first embodiment of the present invention.

FIG. 12E is an explanatory diagram when the puncture instrument punctures the puncture port according to the first embodiment of the present invention.

FIG. 13A is a schematic cross-sectional view of a manufacturing process of a puncture port according to a second embodiment, and a process of preparing a first port member.

FIG. 13B is a view of a state in which a welding pin is inserted into the first port member from the state shown in FIG. 13A.

FIG. 13C is a diagram for explaining a providing step of providing the first port member between a pair of sheet-shaped members which are overlapped in an opposite manner from the state shown in FIG. 13B.

FIG. 13D is a diagram of a first welding step of welding a portion where the first port member and the pair of sheet members overlap each other from the state shown in FIG. 13C.

FIG. 13E is a diagram of an insertion step of removing the welding pin from the state shown in FIG. 13D and inserting the entire second port member into the first port member.

FIG. 13F is a diagram of a second welding step in which the welding pin is inserted into the second port member from the state shown in FIG. 13E, and a portion where the first port member, the second port member, and the pair of sheet-shaped members overlap is welded.

FIG. 14A is an explanatory diagram of a puncture port according to a comparative example.

FIG. 14B is a diagram of a state in which a portion where a first port-shaped member, a second port-shaped member, and the pair of sheet-shaped members shown in FIG. 14A are overlapped to each other is welded.

FIG. 15 is an explanatory view of a use state of a liquid storage container provided with a puncture port of a comparative example.

### PREFERRED MODE FOR CARRYING OUT THE INVENTION

Preferred embodiments of a puncture port and a liquid storage container according to the present invention will now be described with reference to the drawings. The liquid storage container is mainly made of a sheet-shaped member made of a thermoplastic resin having flexibility, and is used for storing medical liquids such as cells such as stem cells collected from a biological sample, cell preparations produced by culturing and processing these cells, blood, and blood preparations produced by processing blood. Further, the puncture port and the liquid storage container of the present invention are applicable to a case where a liquid requiring sterility is stored in addition to such a medical liquid.

### First Embodiment

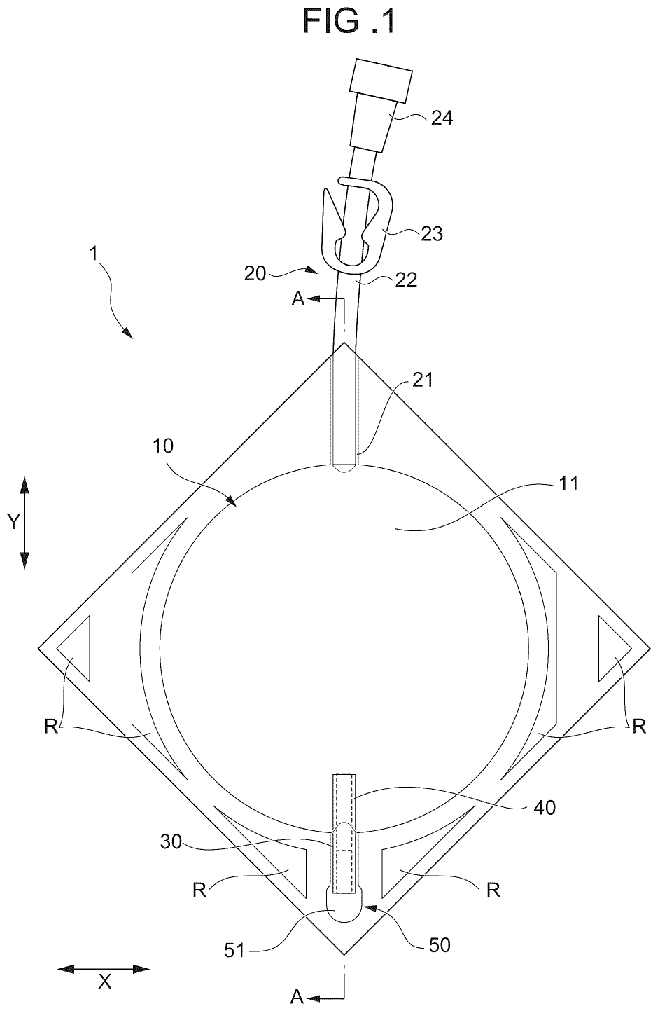

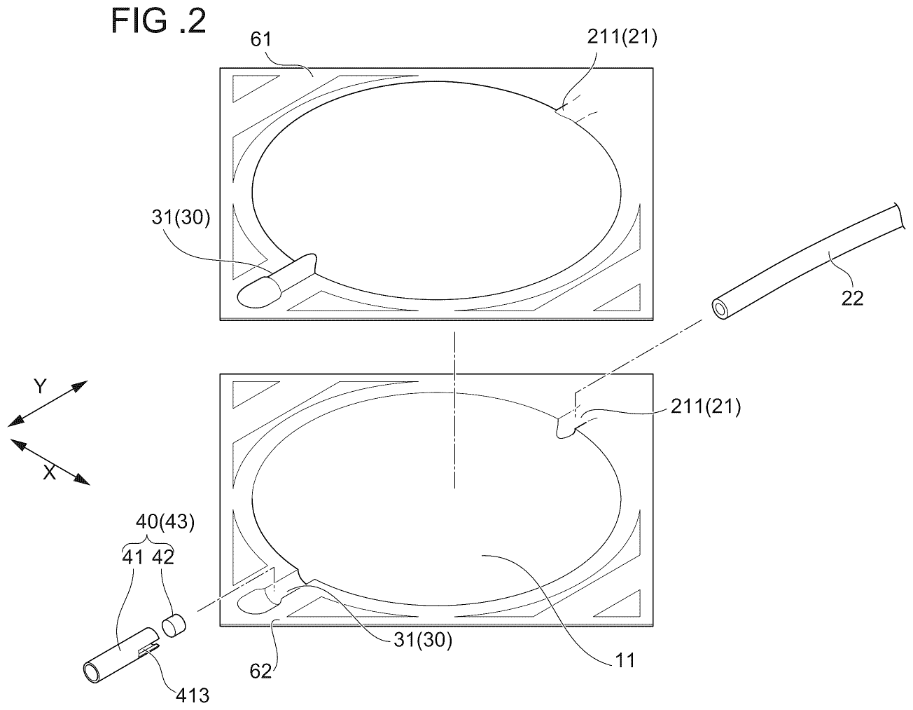

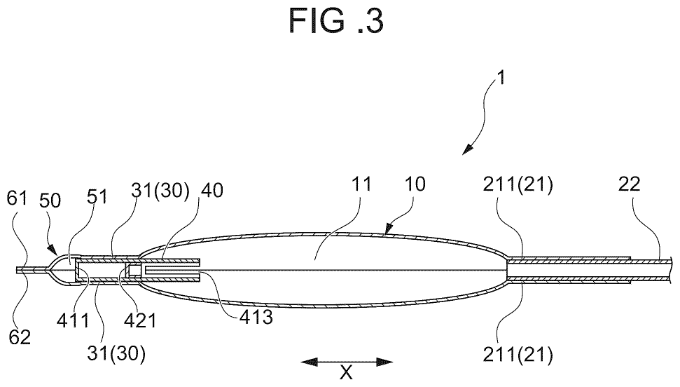

First, a liquid storage container 1 according to a first embodiment will be described with reference to FIGS. 1 to 3. As shown in FIG. 1, the liquid storage container 1 of the first embodiment includes a liquid accommodation portion 10, a liquid introduction portion 20, a liquid discharge portion 30, a puncture port 40 provided in the liquid discharge portion 30, and a puncture port accommodation portion 50.

As shown in FIGS. 1 to 3, the liquid accommodation portion 10 is formed by stacking a pair of sheet-shaped members 61 and 62 and joining most of the peripheral edge portions of the sheet-shaped members 61 and 62. The liquid accommodation portion 10 has a liquid accommodation space 11, which is a space surrounded by sheet-shaped members 61 and 62 having peripheral edge portions joined to each other. In the first embodiment, as shown in FIG. 1, the liquid accommodation portion 10 has a circular shape in a plan view.

The liquid introduction portion 20 is used for introducing a liquid into the liquid accommodation portion 10. The liquid introduction portion 20 includes a liquid introduction path 21 and a liquid introduction tube 22 provided in the liquid introduction path 21. The liquid introduction path 21 is provided in each of the sheet-shaped members 61 and 62, and includes a liquid introduction groove 211 extending outward from the liquid accommodation portion 10. The liquid introduction groove 211 has one end portion which is continuous with the liquid accommodation space 11. The liquid introduction groove 211 also has the other end portion which may extend to an edge portion of each of the sheet-shaped members 61 and 62 (an outer edge of a portion where the sheet-shaped members 61 and 62 are joined).

The liquid introduction tube 22 is provided in the liquid introduction path 21. The liquid introduction tube 22 guides a liquid such as a cell collected from a biological sample to the liquid accommodation portion 10 in a sterile and airtight state. The liquid introduction tube 22 is made of thermoplastic resin such as EVA resin. In the first embodiment, the liquid introduction tube 22 is provided in the liquid introduction groove 211 provided in the sheet-shaped members 61 and 62 such that one end of the liquid introduction tube 22 communicates with the liquid accommodation space 11. A tube clip 23 for opening and closing a flow path of the liquid introduction tube 22 is attached to the liquid introduction tube 22. Further, a connection port 24 to which an instrument such as a syringe used for introducing a cell into the liquid storage container 1 can be connected is attached to the tip portion of the liquid introduction tube 22.

The liquid discharge portion 30 is used to discharge the liquid accommodated in the liquid accommodation portion 10. The liquid discharge portion 30 is provided at a position opposed to a position where the liquid introduction portion 20 is provided in the circular liquid accommodation portion 10. The liquid discharge portion 30 has a recessed groove 31 provided in each of the sheet-shaped members 61 and 62, and extends to the outside of the liquid accommodation portion 10. The liquid discharge portion 30 has one end portion which is continuous with the liquid accommodation space 11.

The puncture port 40 is provided in the liquid discharge portion 30. The puncture port 40 includes a cylindrical port main body portion 43, a first partition 411, and a second partition 421. In the first embodiment, the puncture port 40 includes a first port member 41 and a second port member 42.

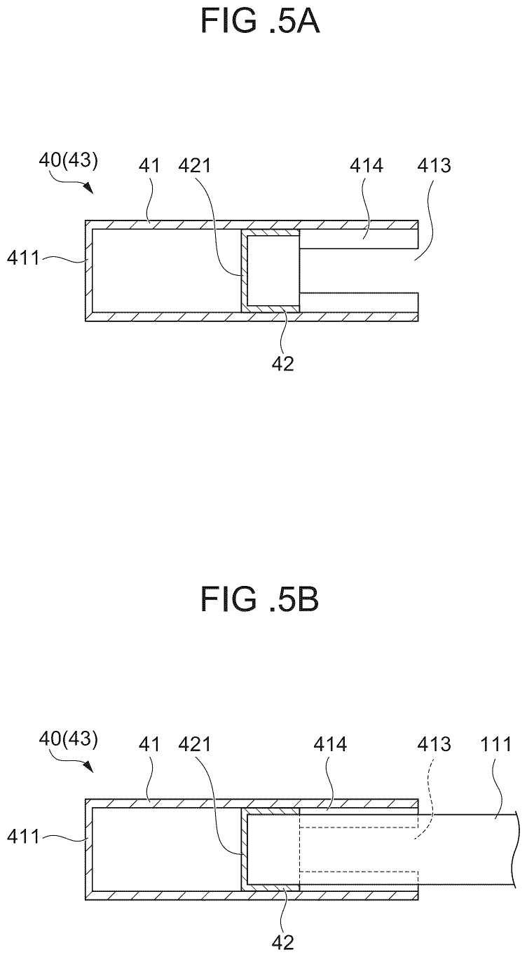

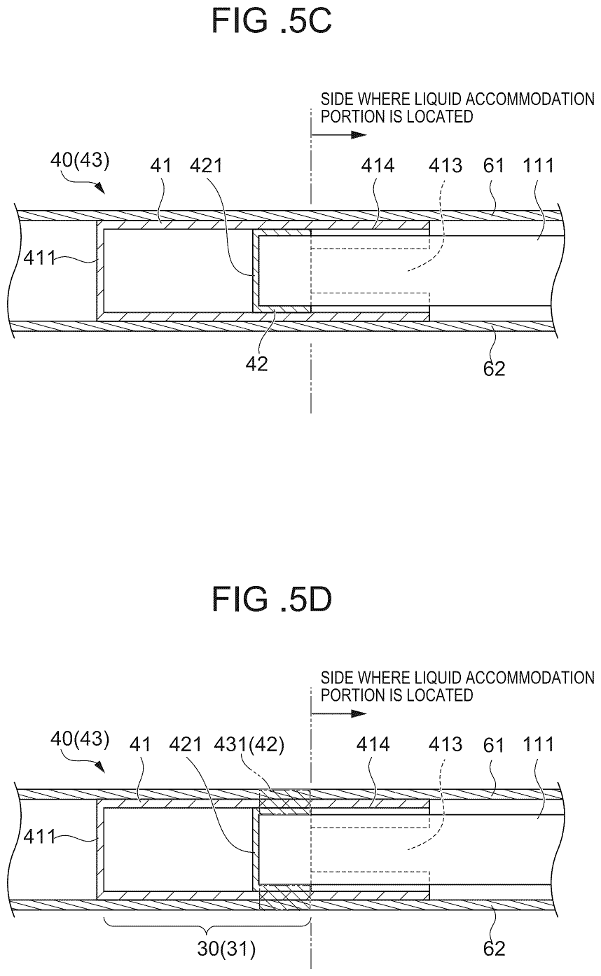

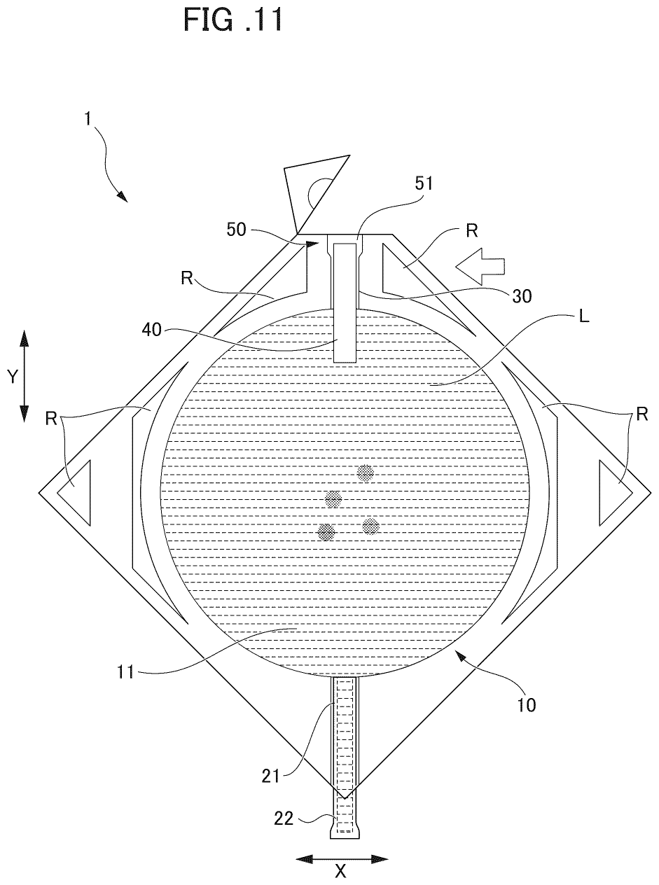

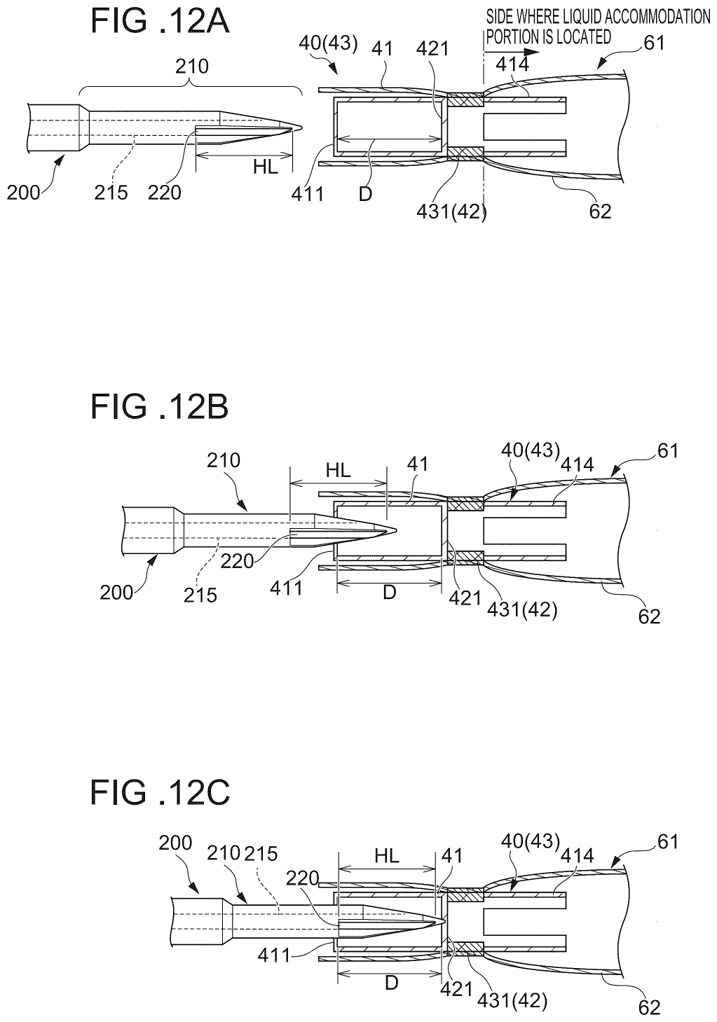

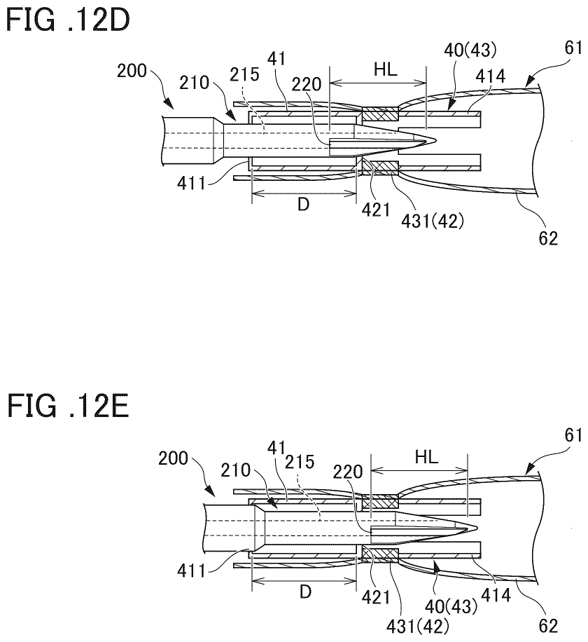

The first port member 41 has a cylindrical shape having one end portion closed by the first partition 411 (see FIGS. 5A to 5D). A pair of slits 413 extending in the longitudinal direction of the first port member 41 is provided in the opening on the other end portion of the first port member 41. The first port member 41 is provided such that the other end portion where the pair of slits is provided is positioned adjacent to the liquid accommodation portion 10. In other words, the opening on the other end portion is provided so as to face the liquid accommodation portion 10. The pair of slits 413 is provided in a portion not along the surfaces of the sheet-shaped members 61 and 62. With such a configuration, a portion of the opening of the first port member 41, in which the pair of slits 413 is not provided, extends along the surfaces of the sheet-shaped members 61 and 62, and serves as a protective portion 414 that prevents the tip portion of a puncture instrument such as a bottle needle from directly contacting the sheet-shaped members 61 and 62 during puncture. Further, the pair of slits 413 facilitates the flow of the accommodated liquid toward the opening portion 220 (see FIG. 12) of the puncture instrument 200.

The second port member 42 has a cylindrical shape having one end portion closed by the second partition 421, and has an outer diameter substantially equal to an inner diameter of the first port member 41 (see FIGS. 5A to 5D). The second port member 42 has a shorter length than the first port member 41. Then, the second port member 42 is inserted into the first port member 41 in a state in which the opening on the other end portion faces the liquid accommodation portion 10, and is provided in a portion of the first port member 41 where the pair of slits 413 is not provided.

The puncture port 40 (the port main body portion 43) is provided in the liquid discharge portion 30 in a state where the second port member 42 is inserted into the first port member 41. In the present embodiment, a portion of the first port member 41 adjacent to the one end portion (a portion of the port main body portion 43) projects outward from the liquid discharge portion 30. A portion of the first port member 41 may not protrude outward from the liquid discharge portion 30. The first port member 41 and the second port member 42 of the puncture port 40 are made of a thermoplastic resin such as EVA resin.

In the puncture port 40, the distance D between the first partition 411 and the second partition 421 is set longer than the length HL of an opening portion 220 of a through hole 215 provided in a needle tube portion 210 of the puncture instrument 200 to be inserted into the puncture port 40 (see FIG. 12). The relationship between the distance D and the length HL of the opening portion 220 will be described later.

The inner diameter of the first port member 41 and the inner diameter of the second port member 42 are larger than the outer diameter of the insertion portion of the puncture instrument. With such a configuration, it is possible to reduce the contact area between the inner peripheral surface of the puncture port 40 and the outer peripheral surface of the insertion portion of the puncture instrument. Therefore, it is possible to reduce the puncture resistance when the puncture instrument is punctured in the puncture port 40.

The puncture port accommodation portion 50 includes a portion in which the sheet-shaped members 61 and 62 of the liquid accommodation portion 10 extend toward the liquid discharge portion 30. The sheet-shaped members 61 and 62 extend beyond the outer end portion (the other end portion) of the first port member 41 of the puncture port 40 (the port main body portion 43). Further, the extended portions of the sheet-shaped members 61 and 62 are joined by welding the peripheral portion of the puncture port 40 in a plan view, i.e., the outer side of the portion separated from the puncture port 40 by a predetermined distance, whereby the puncture port accommodation portion 50 having the puncture port accommodation space 51 surrounded by the sheet-shaped members 61 and 62 is formed. By forming the puncture port accommodation portion 50, as described later, it is possible to maintain the sterility of the puncture port 40 until the puncture port accommodation portion 50 is opened (cut in the width direction X) and the puncture port 40 is punctured with a puncture instrument such as a bottle needle and connected with each other.

From the viewpoint of maintaining the strength of the liquid storage container 1 and suitably opening the opening portion of the puncture port accommodation portion 50, it is preferable to use an EVA resin (ethylene-vinyl acetate copolymer resin) having flexibility and elasticity as the sheet-shaped members 61 and 62. The thickness of the sheet-shaped members 61 and 62 is preferably 0.2 mm to 0.7 mm, and more preferably 0.35 mm to 0.5 mm.

In addition, by forming the sheet-shaped members 61 and 62 and the puncture port 40 with the same material, when the sheet-shaped members 61 and 62 and the puncture port 40 are stored at a low temperature, such as by cryopreservation, the deformation characteristics of the sheet-shaped members 61 and 62 and the puncture port 40 become the same, so that it is possible to enhance the sealing performance between the partitions in the puncture port 40 and the sealing performance of the liquid accommodation space 11.

In the first embodiment, as shown in FIG. 1, the edge portion of the puncture port accommodation space 51 is formed in a curved shape having no corner portion in the vicinity of the puncture port 40. By forming the edge portion of the puncture port accommodation space 51 in a curved shape having no corner portion in the vicinity of the puncture port 40, when the liquid storage container 1 is sterilized using the ethylene oxide gas (EOG), it is possible to suppress concentration of a force at one point of the edge portion of the puncture port accommodation space 51 in a state where the EOG penetrates the puncture port accommodation space 51 and the puncture port accommodation space 51 expands.

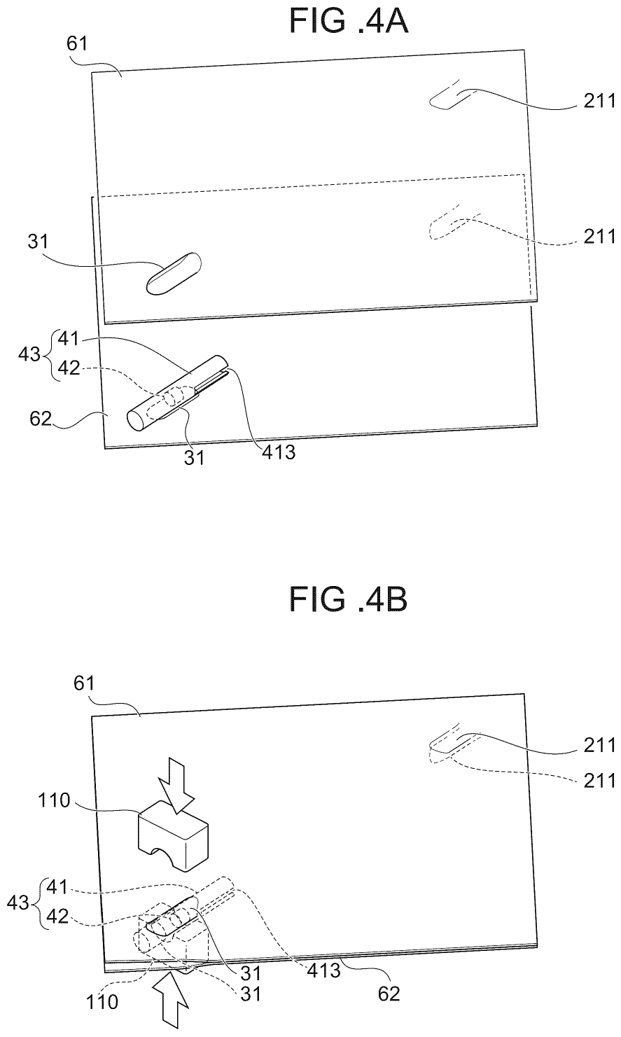

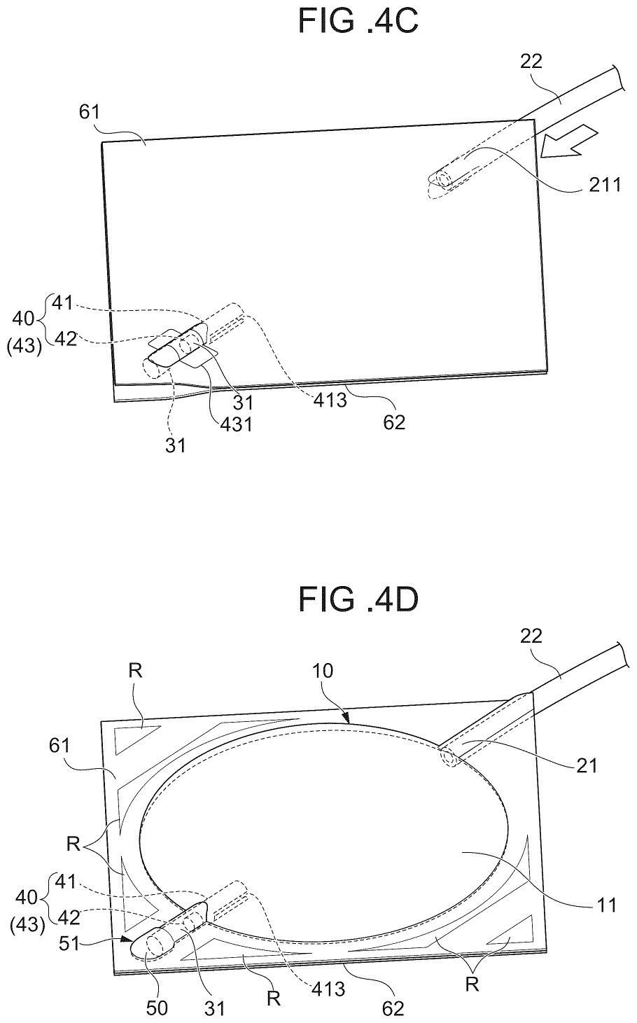

Next, a method of manufacturing the liquid storage container 1 of the first embodiment will be described with reference to FIGS. 4A to 5D. FIGS. 4A to 4D are exploded perspective views in the manufacturing step of the liquid storage container 1, and FIGS. 5A to 5D are schematic cross-sectional views in the manufacturing step of the puncture port 40.

First, as shown in FIG. 4A, the liquid introduction groove 211 and the recessed groove 31 corresponding to the shape of the liquid discharge portion 30 are formed in the sheet-shaped members 61 and 62 by three-dimensional molding. In the first embodiment, three-dimensional shapes having the same shape are formed on the sheet-shaped members 61 and 62, respectively.

Next, the entire second port member 42 is inserted into the interior of the first port member 41 (insertion step, see FIG. 5A). Next, a welding pin 111 is inserted into the second port member 42, and in this state (see FIG. 5B), the first port member 41 into which the second port member has been inserted is provided in the recessed groove 31 of one of the sheet-shaped members (the sheet-shaped member 62), and then the other of the sheet-shaped members (the sheet-shaped member 61) is superimposed or overlapped on the one of the sheet-shaped members so that the positions of the liquid introduction groove 211 and the recessed groove 31 match with each other (providing step, refer to FIG. 5C).

In the step of inserting the second port member 42 into the first port member 41 and inserting the welding pin 111 into the second port member 42, any order may be used. That is, in the providing step, it suffices if the first port member 41 and the second port member 42 are provided in the recessed grooves 31 in a state in which the second port member 42 is inserted into the first port member 41 and the welding pin 111 is provided in the second port member 42.

Next, as shown in FIG. 4B, the overlapped sheet-shaped members 61 and 62, and the first port member 41 and the second port member 42 provided between the sheet-shaped members 61 and 62 are sandwiched and welded by the welding pins 111 and welding molds 110 and 110 at the recessed grooves 31 and in the vicinity of the recessed grooves 31 (the welding pin 111 is not shown). The welding molds 110 are provided to weld the outer peripheral surface of the second port member 42 and the inner peripheral surface of the first port member 41 in contact with the outer peripheral surface of the second port member 42. With such a configuration, the sheet-shaped members 61 and 62 and the port main body portion 43 (the first port member 41 and the second port member 42) provided between the sheet-shaped members 61 and 62 are welded to each other at the recessed grooves 31 and in the vicinity thereof to form a welded portion 431 (see FIGS. 4C and 5D). The welded portion 431 is formed at an end portion of the recessed groove 31 serving as the liquid discharge portion 30, and the end portion thereof is located on the side where the liquid accommodation portion 10 is provided, that is, located at a boundary portion of the liquid discharge portion 30 with the liquid accommodation portion 10.

Here, the boundary portion of the liquid discharge portion 30 with the liquid accommodation portion 10 includes the end portion of the recessed groove 31 serving as the liquid discharge portion 30 on the side where the liquid accommodation portion 10 is provided, and a position slightly (about 1 mm to 3 mm) shifted outward from the end portion. That is, even when the position where the welded portion 431 is provided is slightly shifted outward from the position on the extension line of the outer edge of the liquid accommodation space 11 (the portion where the liquid discharge portion 30 is not provided), the position where the welded portion 431 is provided is included in the “boundary portion of the liquid discharge portion 30 with the liquid accommodation portion 10”.

Next, as shown in FIG. 4C, the liquid introduction tube 22 in which a pin is inserted (not shown) is provided in the portions of the sheet-shaped members 61 and 62 in which the liquid introduction grooves 211 are provided.

Next, as shown in FIG. 4D, in a state in which the sheet-shaped members 61 and 62 are overlapped so that the positions of the liquid introduction groove 211 and the recessed groove 31 match with each other, the peripheral edge portions of the sheet-shaped members 61 and 62 which are located outside the portion forming the liquid accommodation portion 10 are joined by welding to form the liquid accommodation portion 10 (liquid accommodation portion forming step), and the peripheral edge portions of the puncture port 40 is joined by welding to form the liquid discharge portion 30 (liquid discharge portion forming step) and to form the puncture port accommodation portion 50. Further, the liquid introduction tube 22 is welded to the sheet-shaped members 61 and 62 to form the liquid introduction path 21. Here, the first port member 41, the second port member 42, and the sheet-shaped members 61 and 62 are joined to each other by the welded portion 431 at the boundary portion of the liquid discharge portion 30 with the liquid accommodation portion 10. At this time, a region R where high-frequency welding (thermal welding) is not performed may be provided in a portion of the portion located outside the liquid accommodation portion 10.

Thus, the liquid storage container 1 having the liquid accommodation portion 10 and the puncture port accommodation portion 50 is manufactured. Here, in the first embodiment, although the three-dimensional molding is not performed on the portions of the sheet-shaped members 61 and 62 corresponding to the liquid accommodation portion 10 and the puncture port accommodation portion 50, the sheet-shaped member 61 and the sheet-shaped member 62 are joined to each other in a state in which the puncture port 40 having a predetermined diameter (thickness) is sandwiched therebetween, so that the liquid accommodation space 11 and the puncture port accommodation space 51 each having a predetermined volume are formed between the sheet-shaped member 61 and the sheet-shaped member 62.

The liquid storage container 1 is then subjected to an EOG sterilization treatment. In the EOG sterilization process, in a state in which the liquid storage container 1 is provided inside the sterilizer, the EOG is introduced into the sterilizer at a predetermined pressure to sterilize the outer surface of the liquid storage container 1, and at the same time, the EOG penetrates into the liquid accommodation space 11 and the puncture port accommodation space 51, so that the inside of the liquid accommodation portion 10 and the inside of the puncture port accommodation portion 50 are also sterilized.

In the first embodiment, by forming the edge portion of the puncture port accommodation space 51 in a curved shape having no corner portion in the vicinity of the puncture port 40, it is possible to suppress concentration of a force at one point of the edge portion of the puncture port accommodation space 51 in a state where the EOG penetrates into the puncture port accommodation space 51 and the puncture port accommodation space 51 expands in the EOG sterilization step. This prevents the puncture port accommodation portion 50 from being damaged in the EOG sterilization step.

It is possible to manufacture the puncture port 40 and the liquid storage container 1 according to the first embodiment by the manufacturing method described above.

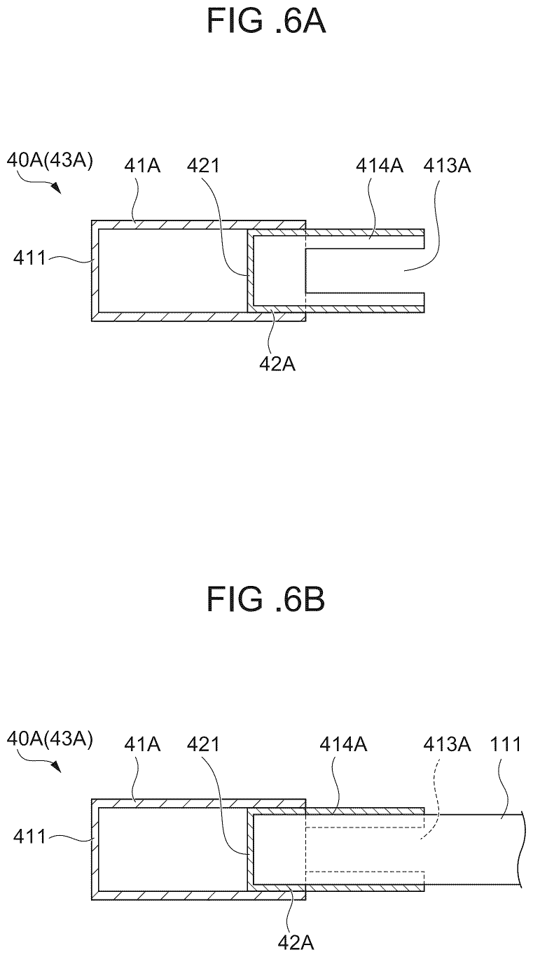

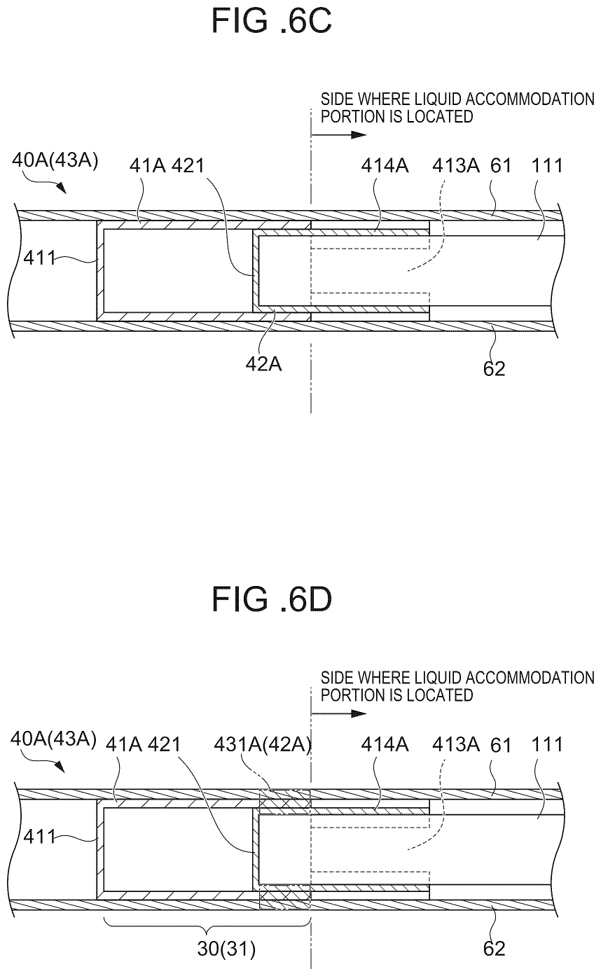

Next, Modified Example 1 of the shape of the puncture port according to the first embodiment is shown in FIGS. 6A to 6D. The puncture port 40A (the port main body portion 43A) shown in FIG. 6 differs from the puncture port 40 of the first embodiment in the shapes of the first port member 41A and the second port member 42A. In the modified example, a portion of the second port member 42A is inserted into the first port member 41A.

The first port member 41A has a cylindrical shape having one end portion closed by the first partition 411 (see FIGS. 6A to 6D). In addition, the first port member 41A is provided such that the opening on the other end portion faces the liquid accommodation portion 10.

The second port member 42A has a cylindrical shape having one end portion closed by the second partition 421, and the outer diameter thereof is substantially equal to the inner diameter of the first port member 41A. A pair of slits 413A and a protective portion 414A extending in the longitudinal direction of the second port member 42A are provided at the opening on the other end portion of the second port member 42A. The second port member 42A is provided such that the other end portion where the pair of slits is provided is positioned adjacent to the liquid accommodation portion 10. In other words, the second port member 42 is provided such that the opening on the other end portion faces the liquid accommodation portion 10, and the pair of slits 413A and the protective portion 414A project from the first port member 41A.

In Modified Example 1, as shown in FIG. 6A, in the above-described insertion step, a portion of the second port member 42A (one end portion where the second partition 421 is provided) is inserted into the first port member 41A. Then, the welding pin 111 is inserted into the second port member 42A, and the portion where the first port member 41A, the second port member 42A, and the recessed grooves 31 (the sheet-shaped members 61 and 62) serving as the liquid discharge portion 30 overlap is welded to form a welded portion 431A. In this way, the puncture port 40A (the port main body portion 43A) is formed by one welding step, and the boundary portion with the liquid accommodation portion 10 is joined by the welded portion 431A.

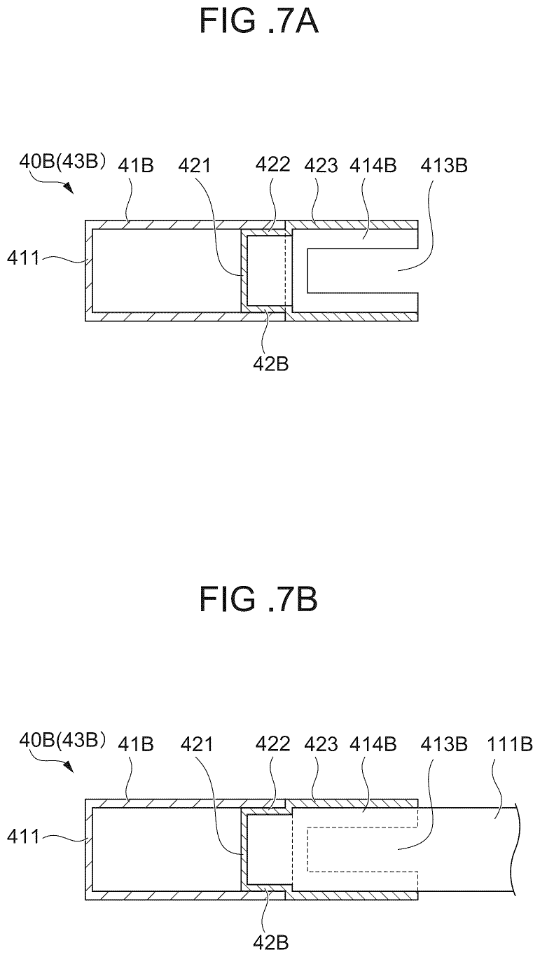

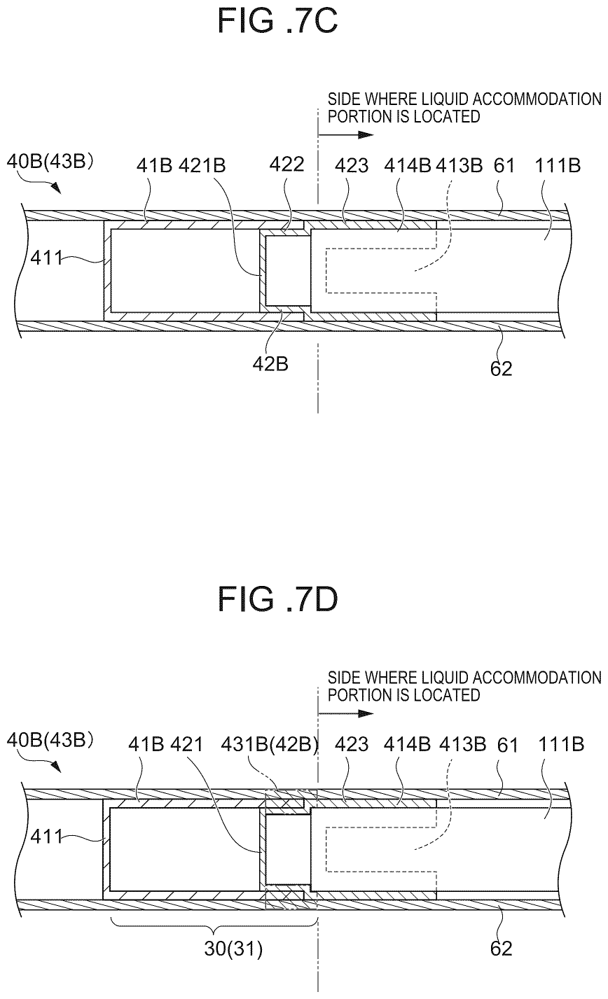

Next, Modified Example 2 of the shape of the puncture port according to the first embodiment is shown in FIGS. 7A to 7D. A puncture port 40B (a port main body portion 43B) shown in FIG. 7 differs from the puncture port 40 of the first embodiment in the shape of a second port member 42B. In the modified example, the second port member 42B includes a small diameter portion 422 and a large diameter portion 423, and the small diameter portion 422, which is a portion of the second port member 42B, is inserted into the first port member 41B.

The first port member 41B has a cylindrical shape having one end portion closed by the first partition 411 (see FIGS. 7A to 7D). In addition, the first port member 41B is provided such that the opening on the other end portion faces the liquid accommodation portion 10.

The second port member 42B has a cylindrical shape having one end portion closed by the second partition 421. Further, the second port member 42B includes a small diameter portion 422 having an outer diameter substantially equal to the inner diameter of the first port member 41B at one end portion thereof, and a large diameter portion 423 which is continuous with the small diameter portion 422 and has a diameter substantially equal to the inner diameter and the outer diameter of the first port member 41B at the other end portion thereof. Further, a pair of slits 413B and a protective portion 414B extending in the longitudinal direction of the second port member 42B are provided at the opening on the other end portion of the second port member 42B. The second port member 42B is provided such that the other end portion where the pair of slits is provided is positioned adjacent to the liquid accommodation portion 10. In other words, the opening on the other end portion is provided so as to face the liquid accommodation portion 10.

In Modified Example 2, as shown in FIG. 7A, in the above-described insertion step, a portion of the second port member 42B (the small diameter portion 422) is inserted into the first port member 41B. At the time of this insertion, by inserting until a step portion between the small diameter portion 422 and the large diameter portion 423 is brought into contact with the end face of the opening of the first port member 41B, the positioning thereof can be easily performed. As shown in FIG. 7B, the welding pin 111B has a shape which is configured to contact the inner wall of the second port member 42B, and is inserted into the second port member 42B. Then, the portion where the first port member 41B, the small diameter portion 422 of the second port member 42B, and the recessed groove 31 (the sheet-shaped members 61 and 62) serving as the liquid discharge portion 30 overlap and the portion where the second port member 42B and the recessed groove 31 serving as the liquid discharge portion 30 (the sheet-shaped members 61 and 62) are welded to form a welded portion 431B. In this way, the puncture port 40B (the port main body portion 43B) is formed by one welding step, and the boundary portion of the liquid discharge portion 30 with the liquid accommodation portion 10 is joined by the welded portion 431B.

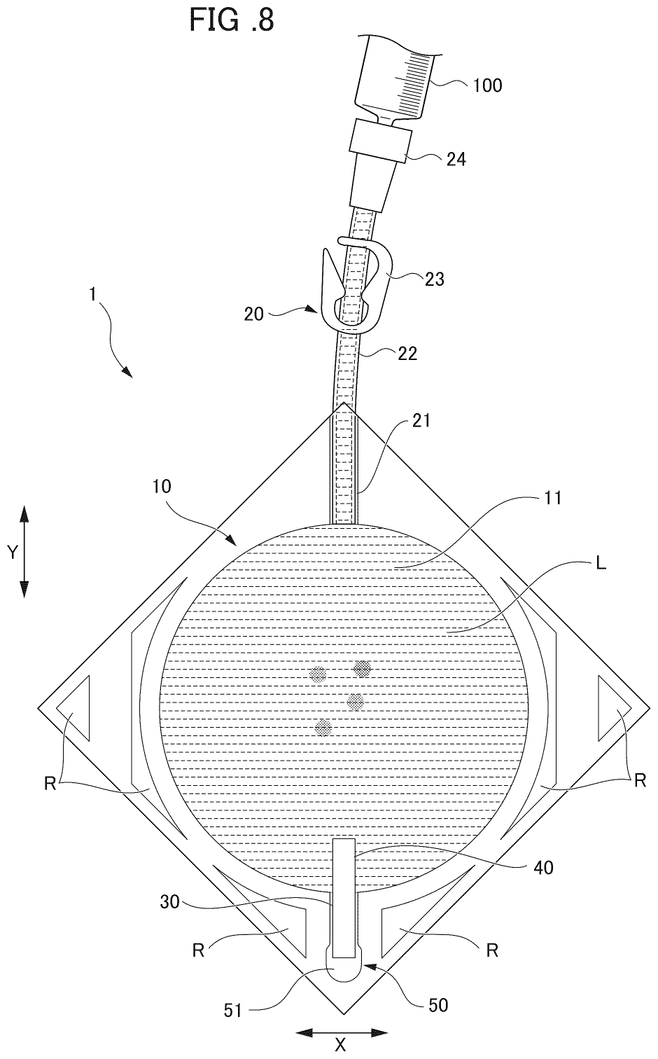

Next, a method of using the liquid storage container 1 of the first embodiment will be described with reference to FIGS. 8 to 12.

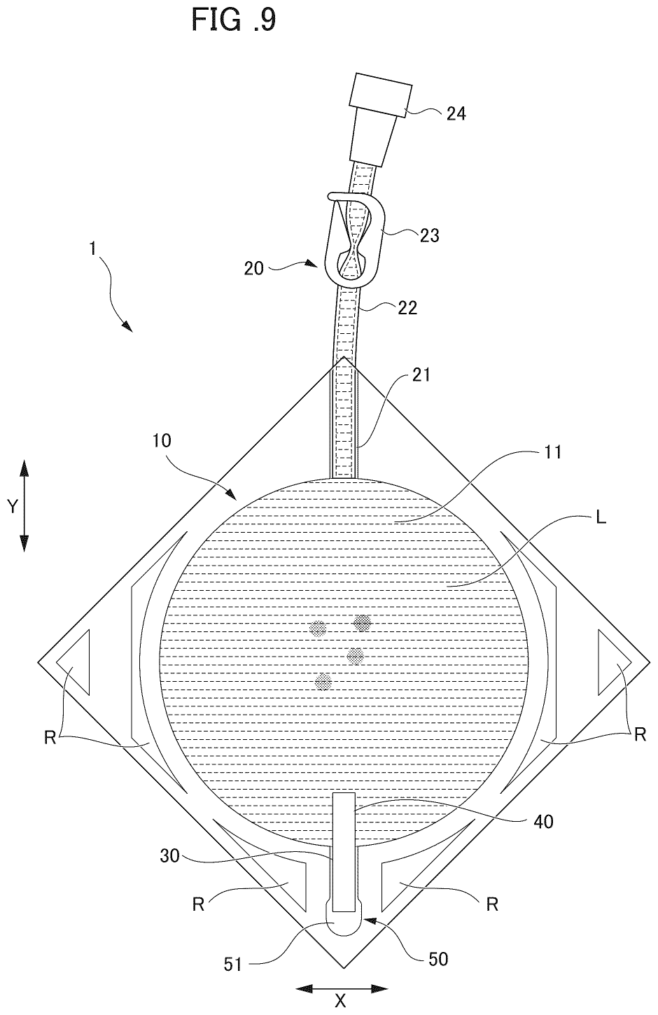

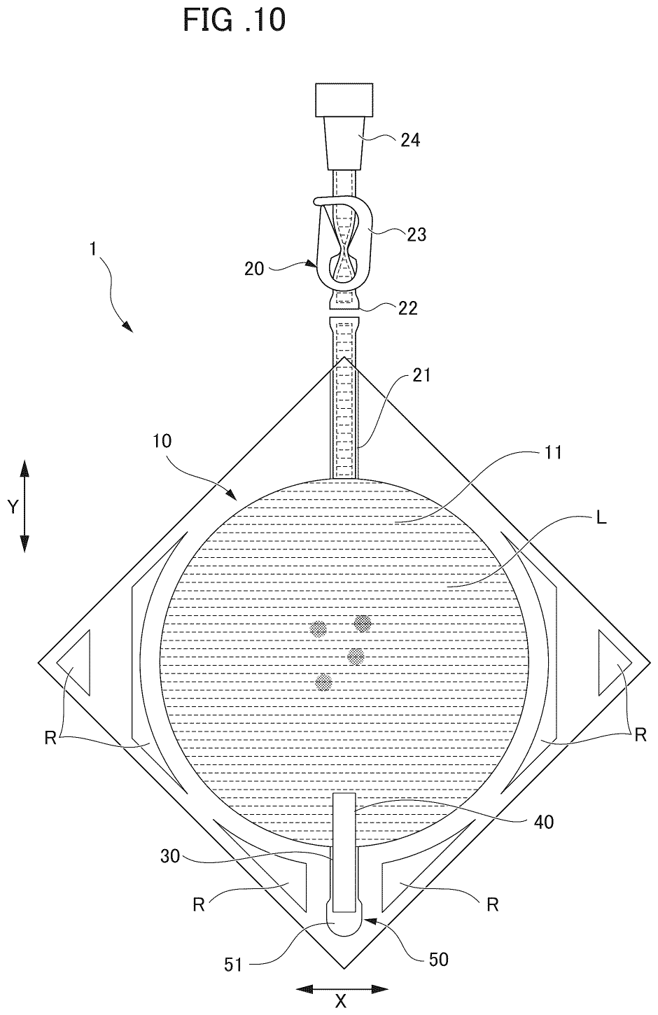

When the liquid is accommodated in the liquid storage container 1, as shown in FIG. 8, the liquid L is introduced into the liquid accommodation portion 10 through the liquid introduction tube 22 by an instrument 100 such as a syringe. After the liquid L is accommodated in the liquid accommodation portion 10, as shown in FIG. 9, the flow path of the liquid introduction tube 22 is closed by the tube clip 23. Next, as shown in FIG. 10, the liquid introduction tube 22 is fused on the side of the tube clip 23 adjacent to the liquid accommodation portion 10, whereby the liquid storage container 1 is sealed. In this state, the liquid storage container 1 is stored.

When the liquid accommodated in the stored liquid storage container 1 is used, as shown in FIG. 11, an end portion of the puncture port accommodation portion 50 in the Y direction is cut by scissors or the like in the width direction X. Then, due to the elasticity of the flexible sheet-shaped members 61 and 62, the cut portion of the puncture port accommodation portion 50 opens in the thickness direction of the sheet-shaped members 61 and 62. In this state, the tip portion of the puncture instrument 200 such as a bottle needle is inserted into the puncture port 40, and the liquid accommodated in the liquid accommodation portion 10 is collected.

A state in which the puncture instrument 200 punctures the puncture port 40 will be described in detail with reference to FIG. 12. In the present embodiment, a case where a bottle needle is used as the puncture instrument 200 will be described. The puncture instrument 200 has the needle tube portion 210 to be inserted into the puncture port 40, as shown in FIG. 12A. The needle tube portion 210 has a through hole 215 penetrating in the longitudinal direction. Further, the tip side of the needle tube portion 210 has a tapered surface having a predetermined slope angle, and the needle tube portion 210 has an opening portion 220 of the through hole 215 opened on the tapered surface. The opening portion 220 of the through hole 215 in the needle tube portion 210 has a predetermined length HL in the puncture direction of the puncture instrument 200. The puncture port 40 includes the two partitions, i.e., the first partition 411 and the second partition 421 thereinside, and is configured such that a distance D between the two partitions is longer than the length HL of the opening portion 220.

Specifically, when a bottle needle is used as the puncture instrument 200, the length HL of the opening portion 220 of the through hole 215 of the bottle needle is set to 11.5 mm to 13.4 mm. Therefore, the distance D between the first partition 411 and the second partition 421 in the puncture port 40 is preferably set to 13.5 mm to 26 mm.

FIG. 12B shows a state in which the puncture instrument 200 begins to be inserted into the puncture port 40 from the state shown in FIG. 12A, and the tip portion of the puncture instrument 200 is in the middle of passing through the first partition 411. In this state, the base end side of the opening portion 220 of the through hole 215 is located outside the first partition 411 and the tip side is located on the inner side of the first partition 411 (between the first partition 411 and the second partition 421). Therefore, even if the sealing performance of the space between the first partition 411 and the second partition 421 is temporarily lost, the sealing performance of the space closer to the liquid accommodation portion 10 than the second partition 421 is maintained.

FIG. 12C shows a state in which the puncture instrument 200 is further inserted from the state shown in FIG. 12B, and the opening portion 220 of the through hole 215 is located between the first partition 411 and the second partition 421. In this state, since the entire opening portion 220 of the through hole 215 is inserted between the first partition 411 and the second partition 421, and the penetrated portion of the first partition 411 is closed by the puncture instrument 200, the space between the first partition 411 and the second partition 421 is sealed again.

FIG. 12D shows a state in which the puncture instrument 200 is further inserted from the state shown in FIG. 12C and the tip portion of the puncture instrument 200 is in the middle of passing through the second partition 421. In this state, since the base end side of the opening portion 220 of the through hole 215 is located between the first partition 411 and the second partition 421, and the tip side is located on the inner side of the second partition 421 (the side adjacent to the liquid accommodation portion 10), the space between the first partition 411 and the second partition 421 and the liquid accommodation portion 10 communicate with each other. However, since the penetrated portion of the first partition 411 is closed by the puncture instrument 200, the sealing performance of the space on the inner side from the first partition 411 is maintained.

FIG. 12E shows a state in which the puncture instrument 200 is further inserted from the state shown in FIG. 12D, and the tip portion of the puncture instrument 200 penetrates the second partition 421. In this state, since the entire length of the opening portion 220 of the through hole 215 is located closer to the liquid accommodation portion 10 than the second partition 421, it is possible to take out the liquid favorably, while maintaining the sealing performance in the liquid accommodation portion 10.

### Comparative Example

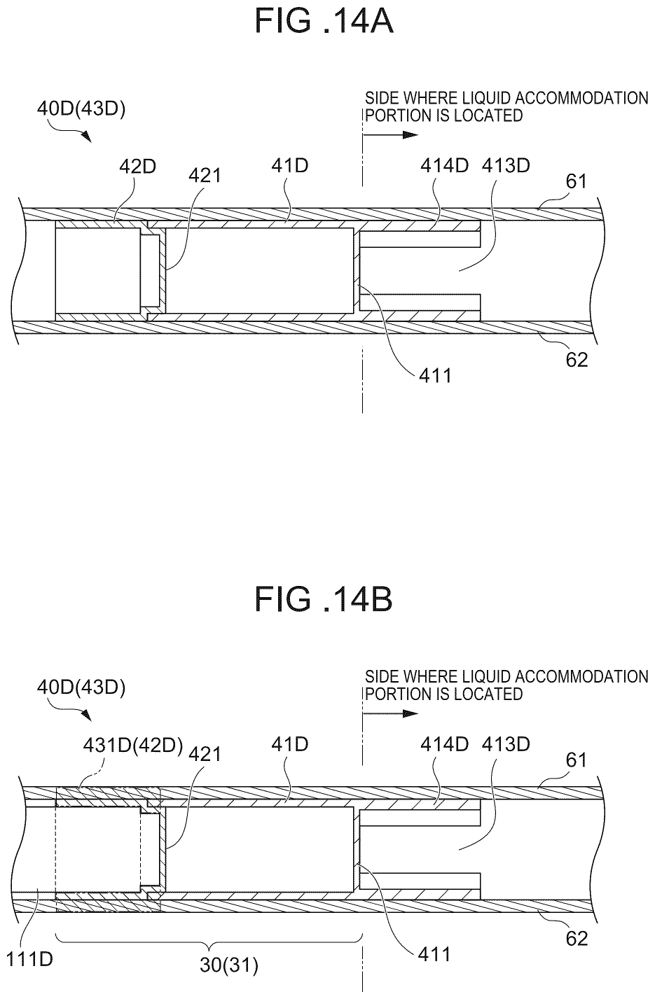

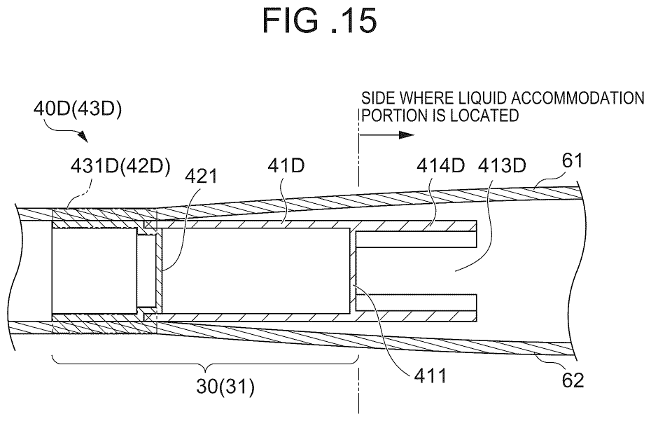

Here, as a comparative example, a liquid storage container having a puncture port 40D in which the opening of each of the first port member 41D and the second port member 42D faces the side opposite to the liquid accommodation portion 10 will be described with reference to FIGS. 14 and 15. In the case of this comparative example, the first port member 41D includes a pair of slits 413D and a protective portion 414D provided at an end portion adjacent to the liquid accommodation portion, and includes a first partition 411 thereinside. In the comparative example, when the portion where the first port member 41D, the second port member 42D, and the sheet-shaped members 61 and 62 overlap is welded in one welding step, the welded portion 431D is formed at a position of the recessed groove 31 (the liquid discharge portion 30) away from the liquid accommodation portion 10 (see FIG. 14B). Therefore, when the liquid is stored in the liquid storage container of the comparative example, since the liquid stored in the liquid accommodation portion enters the inside of the liquid discharge portion 30, it is difficult to take out the liquid in the portion using the puncture instrument (see FIG. 15).

In comparison with the comparative example, in the manufacturing method of the first embodiment (including the modified examples 1 and 2) of the present invention, it is possible to form the puncture port 40 (40A, 40B) by welding the portion where the first port member 41 (41A, 41B), the second port member 42 (42A, 42B) and the sheet-shaped members 61 and 62 in one welding step, and to form the welded portion 431 (431A, 431B) in the boundary portion of the recessed groove 31 (the liquid discharge portion 30) with the liquid accommodation portion 10. Therefore, since the liquid accommodated in the liquid accommodation portion 10 does not enter the liquid discharge portion 30, it is possible to reduce the occurrence of the loss of the contents (see FIGS. 5D, 6D, 7D, 12 and the like).

According to the puncture port 40 and the liquid storage container 1 of the first embodiment, Modified Example 1, and Modified Example 2 described above, the following advantageous effects can be obtained.
(1) The liquid storage container 1 includes the liquid accommodation portion 10, the liquid discharge portion 30, the cylindrical port main body portion 43, and the first partition 411 and the second partition 421 provided in the port main body portion 43. The port main body portion 43 is joined to the liquid discharge portion 30 at a boundary portion between the liquid accommodation portion 10 and the liquid discharge portion 30. With such a configuration, by having two partitions, i.e., the first partition 411 and the second partition 421, it is possible to prevent leakage of contents when puncturing the puncture instrument 200 into the puncture port 40. Further, since the port main body portion 43 and the liquid discharge portion 30 are joined to each other at the boundary portion between the liquid accommodation portion 10 and the liquid discharge portion 30, it is possible to prevent the liquid from entering into the gap between the port main body portion 43 and the liquid discharge portion 30, whereby it is possible to reduce the occurrence of the loss of the contents.
(2) The port main body portion 43 is configured to include the cylindrical first port member 41 having one end portion closed by the first partition 411 and the cylindrical second port member 42 having one end portion closed by the second partition 421. The first port member 41 and the second port member 42 are provided in the liquid discharge portion 30 such that the opening on the other end portion of each of the first port member 41 and the second port member 42 faces the liquid accommodation portion 10. A portion or all of the second port member 42 is provided at a boundary portion between the liquid accommodation portion 10 and the liquid discharge portion 30 inside the first port member 41. Then, the first port member 41, the second port member 42, and the liquid discharge portion 30 are welded at the boundary portion with the liquid accommodation portion 10. With such a configuration, it is possible to form the port main body portion 43 by two members, i.e., the first port member 41 and the second port member 42, and it is possible to form the port main body portion 43 and weld the port main body portion 43 to the liquid discharge portion 30. Therefore, it is possible to provide the port main body portion 43 at low cost.
(3) The second port member 42B is configured to include the small diameter portion 422 having an outer diameter substantially equal to the inner diameter of the first port member 41B at one end portion thereof and the large diameter portion 423 having an outer diameter substantially equal to the outer diameter of the first port member 41B at the other end portion thereof. The second port member 42B is welded to the liquid discharge portion 30 via the first port member 41B at the small diameter portion 422 and directly welded to the liquid discharge portion 30 at the large diameter portion 423. With such a configuration, it is possible to perform the positioning of the second port member 42B with respect to the first port member 41B easily, whereby it is possible to obtain the puncture port 40B having a high sealing performance.
(4) The liquid accommodation portion 10 is formed by welding the peripheral edge portions of the pair of sheet-shaped members 61 and 62 provided in an opposite manner, and the sheet-shaped members 61 and 62, the first port member 41, and the second port member 42 are made of the same material. With such a configuration, when the liquid storage container 1 is stored at a low temperature, for example, when the liquid storage container 1 is cryopreserved, the deformation characteristics of the puncture port 40 and the sheet-shaped members 61 and 62 become similar, it is possible to enhance the sealing performance between the first partition 411 and the second partition 421 inside the puncture port 40 and the sealing performance of the liquid accommodation space 11.
(5) The puncture port 40 is set such that the distance D between the first partition 411 and the second partition 421 is longer than at least the length HL in the puncture direction of the opening portion 220 of the through hole 215 at the tip portion of the needle tube portion 210 of the puncture instrument 200. With such a configuration, when the tip of the opening portion 220 of the through hole 215 of the puncture instrument 200 begins to penetrate the first partition 411, the base end of the opening portion 220 of the through hole 215 of the puncture instrument 200 is positioned between the first partition 411 and the second partition 421, whereby it is possible to prevent leakage of the liquid inside the liquid storage container 1 through the opening portion 220 of the through hole 215 of the puncture instrument 200. Therefore, it is possible to maintain sealing performance in a state in which the liquid is taken out, for example, without fitting the puncture instrument 200 and the puncture port 40. Further, by setting the distance D between the first partition 411 and the second partition 421 in accordance with the puncture instrument 200 having the largest size of the length HL of the opening portion 220 of the through hole 215, it is possible to provide the puncture port 40 having high versatility which can be used regardless of the size (length) of the opening portion 220 of the through hole 215 of the puncture instrument 200. Further, by maintaining the sealing performance in the space located on the inner side of the first partition 411 by the first partition 411, it is possible to increase the degree of freedom in setting the inner diameter of the puncture port 40. That is, since it is possible to maintain the sealing performance without bringing the inner surface of the puncture port 40 into close contact with the outer surface of the puncture instrument 200, by setting the inner diameter of the puncture port 40 to be large, it is possible to handle the puncture instrument 200 of various sizes (outer diameters). Further, since it is possible to reduce the contact area between the outer peripheral surface of the puncture instrument 200 and the inner peripheral surface of the puncture port 40 when the puncture instrument 200 is inserted into the puncture port 40, it is possible to reduce the puncture resistance when the puncture instrument 200 punctures the puncture port 40.
(6) A method of manufacturing the liquid storage container 1 includes: an insertion step of inserting a portion or all of the second port member 42 into the first port member 41 in a state in which the opening on the other end portion of the first port member 41 and the opening on the other end portion of the second port member 42 face in the same direction; a providing step of providing the first port member 41 and the second port member 42 between the pair of sheet-shaped members 61 and 62 which are overlapped in an opposite manner; a welding step of welding the portion where the first port member 41, the second port member 42, and the pair of sheet-shaped members 61 and 62 overlap; and a liquid accommodation portion forming step of welding the peripheral edge portions of the pair of sheet-shaped members 61 and 62 to form the liquid accommodation portion 10 on the side where the openings of the first port member 41 and the second port member 42 are located. The liquid accommodation portion forming step further includes welding the pair of sheet-shaped members 61 and 62 so as to include the portion welded in the welding step. With such a configuration, it is possible to perform the formation of the puncture port 40 and welding at the boundary portion between the sheet-shaped members 61 and 62 at the same time. Therefore, it is possible to manufacture the liquid storage container 1 in a smaller number of steps, when compared to a case in which the puncture port 40 is formed by welding, following which the resulting puncture port 40 is welded to the sheet-shaped members 61 and 62.
(7) The second port member 42B includes the small diameter portion 422 which is provided at one end portion thereof and has an outer diameter substantially equal to the inner diameter of the first port member 41B and a large diameter portion 423 which is provided at the other end portion thereof and has an outer diameter equal to the outer diameter of the first port member 41B. The insertion step further includes inserting the small diameter portion 422 into the first port member 41B until a step difference between the small diameter portion 422 and the large diameter portion 423 is brought into contact with the opening of the first port member 41B. The welding step further includes welding the second port member 42B to the liquid discharge portion 30 via the first port member 41B at the small diameter portion 422, and welding the second port member 42B directly to the liquid discharge portion 30 at the large diameter portion 423. With such a configuration, it is possible to conduct positioning easily in the insertion step.

### Second Embodiment

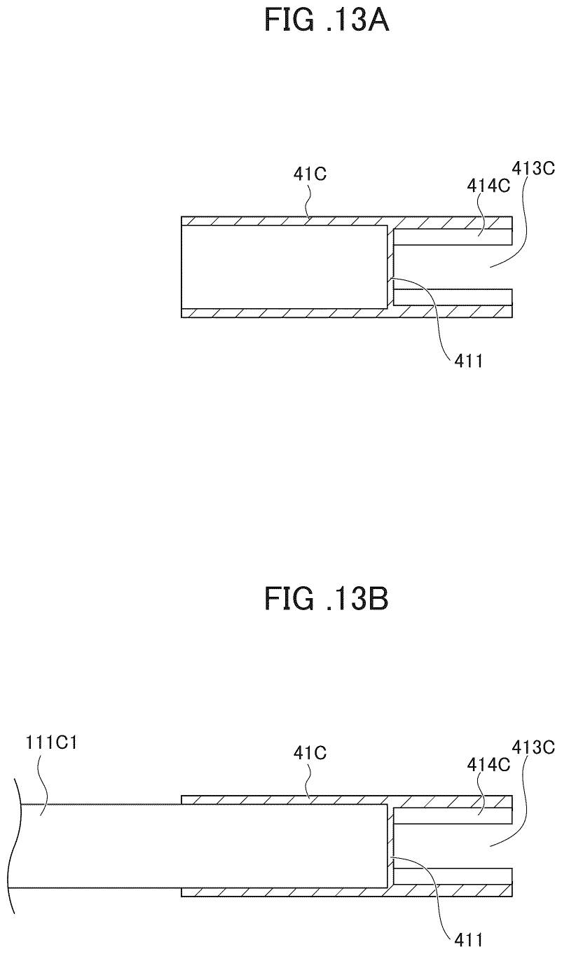

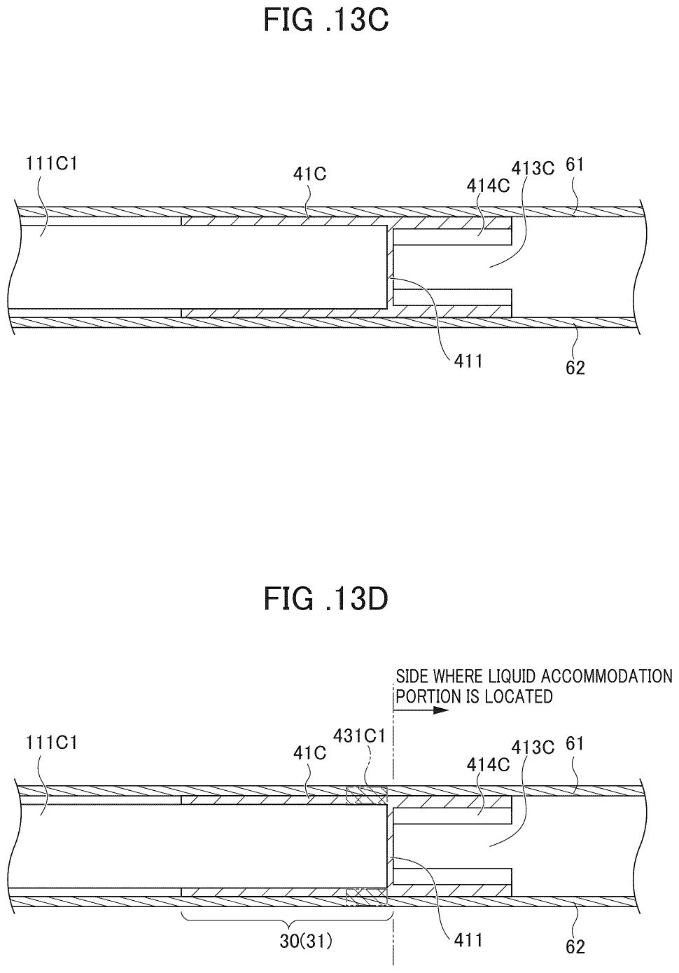

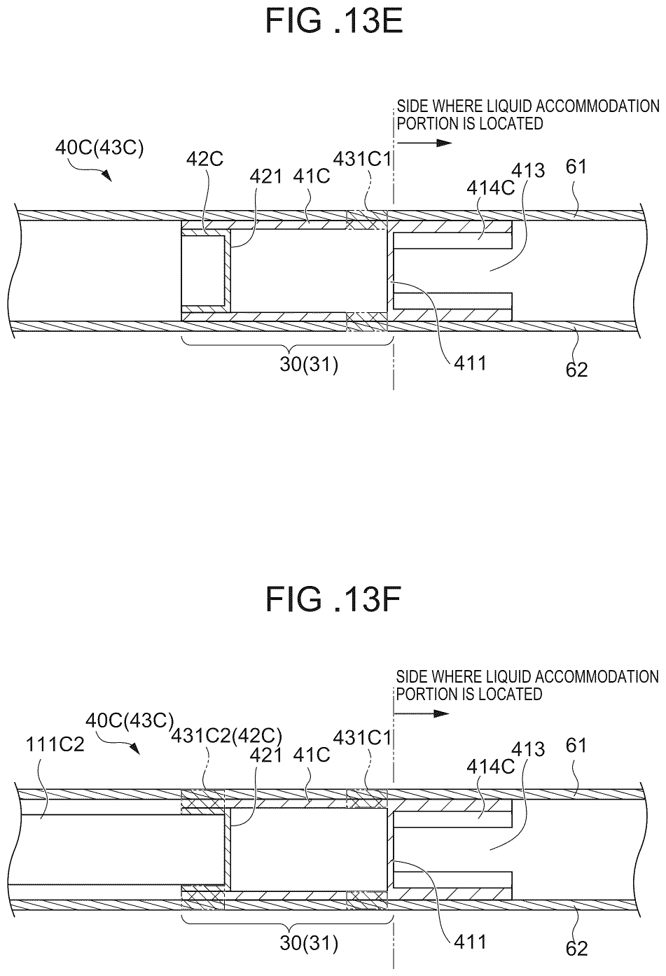

Next, a puncture port 40C included in a liquid storage container of a second embodiment will be described with reference to FIGS. 13A to 13F. The puncture port 40C (the port main body portion 43C) according to the second embodiment differs from the first embodiment in that the puncture port 40C (the port main body portion 43C) includes the first partition 411 inside the first port member 41C, and that the opening of the second port member 42C faces the side opposite to the liquid accommodation portion 10.

FIGS. 13A to 13F are schematic cross-sectional views in the manufacturing process of the puncture port 40C.

As shown in FIG. 13A, the first port member 41C has a cylindrical shape. When the side where the puncture instrument 200 is inserted is defined as the one end portion of the first port member 41C, a pair of slits 413C extending in the longitudinal direction of the first port member 41C is provided on the other end portion of the first port member 41C (the side where the liquid accommodation portion 10 is provided). The first port member 41C has a first partition 411 that is provided closer to the one end portion than the portion where the pair of slits 413C is provided and closes the cylindrical portion.

Next, a welding pin 111C1 is inserted into the first port member 41C, and in this state (see FIG. 13B), the first port member 41C is provided in the recessed groove 31 of one sheet-shaped member (the sheet-shaped member 62), and then the other sheet-shaped member (the sheet-shaped member 61) is overlapped or superimposed so that the positions of the liquid introduction grooves 211 and the recessed grooves 31 match with each other (the providing step, see FIG. 13C).

Next, the overlapped sheet-shaped members 61 and 62 and the first port member 41C provided between the sheet-shaped members 61 and 62 are sandwiched and welded by the welding pin 111C1 and a welding mold (not shown) at the recessed grooves 31 and in the vicinity of the recessed grooves 31. This welding mold is provided at an end portion of the recessed groove 31 serving as the liquid discharge portion 30 on the side where the liquid accommodation portion 10 is provided, and welds the outer peripheral surface of the first port member 41C and the inner peripheral surface of the recessed groove 31 in contact with the first port member 41C. With such a configuration, the sheet-shaped members 61 and 62 and the first port member 41C provided between the sheet-shaped members 61 and 62 are welded to each other at the recessed groove 31 and in the vicinity thereof to form a welded portion 431C1 (see FIG. 13D).

Next, the welding pin 111C1 is removed from the state shown in FIG. 13D, and the entire second port member 42C is inserted into the first port member 41C (the insertion step, see FIG. 13E).

Next, the welding pin 111C2 is inserted into the second port member 42C, and the stacked sheet-shaped members 61 and 62, and the first port member 41C and the second port member 42C disposed between the sheet-shaped members 61 and 62 are sandwiched and welded by the welding pin 111C2 and the welding molds 110 and 110 in the vicinity of the recessed groove 31 to form the welded portion 431C2. In this way, the welded portion 431C1 and the welded portion 431C2 are formed by two welding steps, and the puncture port 40C (the port main body portion 43C) is formed.

Next, in a state in which the sheet-shaped members 61 and 62 are overlapped so that the positions of the liquid introduction grooves 211 and the recessed grooves 31 match with each other in the same manner as in the case described in the first embodiment, the peripheral edge portions of the sheet-shaped members 61 and 62 which are located outside the portion providing the liquid accommodation portion 10 are joined by welding (the liquid accommodation portion forming step) to form the liquid accommodation portion 10, and the peripheral portion of the puncture port 40 is joined by welding to form the liquid discharge portion 30 (the liquid introduction portion forming step), thereby forming the puncture port accommodation portion 50. The liquid storage container having the puncture port 40C is thereby manufactured.

As described in the second embodiment, as long as the puncture port 40C (the port main body portion 43C) and the liquid discharge portion 30 are joined by welding or the like at the boundary portion of the liquid discharge portion 30 with the liquid accommodation portion 10, the same advantageous effects as the above-described effect (1) can be obtained.

The preferred embodiments of the puncture port and the liquid storage container of the present invention have been described above. However, the present invention is not limited to the above-described embodiments, and can be appropriately modified. For example, in the first embodiment, Modified Example 1, Modified Example 2, and the second embodiment, two sheet-shaped members are used as an example of the set of sheet-shaped members for forming the liquid accommodation portion. That is, a pair of sheet-shaped members may be formed with a cylindrical sheet-shaped member or by bending and overlapping one sheet-shaped member.

Further, in the first embodiment, Modified Example 1, Modified Example 2, and the second embodiment, as an example, the pair of slits and the protective portion are provided on a side of the liquid accommodation portion adjacent to the puncture port. However, the present invention is not limited thereto. The puncture port may have a shape that does not extend to the side adjacent to the liquid accommodation portion and does not have a protective portion.

Further, in each embodiment, the liquid discharge portion 30 is provided at a position opposed to the position where the liquid introduction portion 20 is provided in the liquid accommodation portion 10. The liquid introduction portion may be provided at a position which is not opposite to the liquid lead-in portion, for example, at a position which is 90 degrees with respect to the liquid lead-in portion. Further, a plurality of liquid discharge portions may be provided.

In the second embodiment, as an example, the entire second port member is inserted into the first port member. However, the present invention is not limited thereto. That is, similarly to Modified Example 2 of the first embodiment, the second port member may be configured to have a small diameter portion and a large diameter portion, and a portion (a small diameter portion) of the second port member may be inserted into the first port member and welded.

Further, in the first embodiment, Modified Example 1, Modified Example 2, and the second embodiment, the manufacturing method in which the port main body portion including the first port member and the second port member, and the recessed groove is formed by welding in one or two welding steps has been described. However, the present invention is not limited thereto. That is, a liquid storage container obtained by welding the first port member and the second port member in advance to form a port main body portion, and welding the port main body portion and the recessed groove at a boundary portion between the port main body portion and the liquid accommodation portion is also encompassed by the scope of the present invention.

Further, in the first embodiment, the shape of the liquid accommodation portion is circular. That is, it suffices if the shape of the liquid accommodation portion is a curved shape having no corner portions, and therefore, the shape may be an elliptical shape instead of a circular shape. In a case where the liquid accommodation portion has a rectangular shape, the corner portion is preferably rounded. This facilitates removal of air bubbles from the inside of the liquid introduction portion after introduction of the liquid and before sealing the liquid introduction portion.

Further, in the first embodiment and the second embodiment, the puncture port accommodation portion 50 and the liquid accommodation portion 10 are configured without three-dimensional molding on the sheet-shaped members 61 and 62. However, the present invention is not limited thereto. That is, the liquid accommodation portion 10 and the puncture port accommodation portion 50 may be configured with three-dimensional shapes of the sheet-shaped members 61 and 62, respectively, and the sheet-shaped members 61 and 62 may be overlapped so that the positions of the three-dimensional shape portions match with each other to join the sheet-shaped members 61 and 62.

Further, in the first embodiment, the liquid storage container 1 is subjected to EOG sterilization. However, the present invention is not limited thereto. That is, the liquid storage container may be subjected to radiation sterilization such as gamma rays or electron beams.

Further, in each embodiment, a minute through hole may be provided in the first partition 411. With such a configuration, when the liquid storage container is sterilized, the space between the first partition and the second partition can be sterilized more efficiently.

### Explanation of Reference Numerals

1 liquid storage container
10 liquid accommodation portion
20 liquid introduction portion
30 liquid discharge unit
40, 40a, 40b, 40c puncture port
41, 41a, 41b, 41c first port member
42, 42a, 42b, 42c second port member
43 port main body portion
50 puncture port accommodation portion
51: puncture port accommodation space
411 first partition
421 second partition
200 puncture instrument
210 needle tube portion
215 through hole
220 opening portion

1. A liquid storage container including a puncture port puncturable by a puncture instrument including a needle tube portion having a through hole provided therein, the liquid storage container comprising:
a liquid accommodation portion that accommodates a liquid; and
a liquid discharge portion that discharges the liquid accommodated in the liquid accommodation portion,
the puncture port including:
a cylindrical port main body portion; and
a first partition and a second partition provided in the port main body portion, and
the port main body portion being joined with the liquid discharge portion at a boundary portion between the liquid accommodation portion and the liquid discharge portion.

2. The liquid storage container according to claim 1, wherein
the puncture port includes a cylindrical first port member having one end portion closed by the first partition and a cylindrical second port member having one end portion closed by the second partition,
a portion or all of the second port member is provided at the boundary portion inside the first port member, and
the first port member, the second port member, and the liquid discharge portion are welded at the boundary portion.

3. The liquid storage container according to claim 2, wherein the first port member and the second port member are provided in the liquid discharge portion such that an opening on one other end portion of each of the first port member and the second port member faces the liquid accommodation portion.

4. The liquid storage container according to claim 2, wherein
the second port member includes a small diameter portion having an outer diameter substantially equal to an inner diameter of the first port member at the one end portion of the second port member, and a large diameter portion which is continuous with the small diameter portion and has an outer diameter substantially equal to an outer diameter of the first port member at the other end portion of the second port member, and
the second port member is welded to the liquid discharge portion via the first port member at the small diameter portion, and welded to the liquid discharge portion at the large portion.

5. The liquid storage container according to claim 2, wherein
the liquid accommodation portion is provided by welding peripheral edge portions of a set of sheet-shaped members provided in an opposite manner, and
the set of sheet-shaped members, the first port members, and the second port members are made of a same material.

6. The liquid storage container according to claim 1, wherein a distance between the first partition and the second partition in a puncture direction is longer than at least a length of an opening portion of the through hole at a tip portion of the needle tube portion in the puncture direction.

7. A method of manufacturing a liquid storage container that stores a liquid, the liquid storage container including a puncture port puncturable by a puncture instrument including a needle tube portion having a through hole provided therein, a liquid discharge portion, and a liquid accommodation portion, the method comprising:
an insertion step of inserting a portion or all of a second port member into a first port member in a state in which an opening on one other end portion of the first port member having one end portion closed by a first partition and an opening on one other end portion of the second port member having one end portion closed by a second partition face in a same direction;
a providing step of providing the first port member and the second port member between a set of sheet-shaped members overlapped in an opposite manner after the insertion step;
a welding step of welding a portion where the first port member, the second port member, and the set of sheet-shaped members overlap after the providing step; and
a liquid accommodation portion forming step of welding peripheral edge portions of the set of sheet-shaped members to form the liquid accommodation portion on a side where the openings of the first port member and the second port member are located,
wherein the liquid accommodation portion forming step further includes welding the set of sheet-shaped members to include the portion welded in the welding step.

8. The method of manufacturing a liquid storage container according to claim 7, wherein
the second port member includes a small diameter portion having an outer diameter substantially equal to an inner diameter of the first port member at the one end portion of the second port member, and a large diameter portion which is continuous with the small diameter portion and has an outer diameter substantially equal to an outer diameter of the first port member at the other end portion of the second port member,
the insertion step further includes inserting the small diameter portion of the second port member into the first port member until a step difference between the small diameter portion and the large diameter portion of the second port member is brought into contact with the opening of the first port member, and
the welding step further includes welding the second port member to the first port member and the liquid discharge portion at the small diameter portion, and welding the second port member to the liquid discharge portion at the large diameter portion.
